(19) United States
(12) Patent Application Publication
(10) Pub. No.: US 2013/0058508 A1
(43) Pub. Date: Mar. 7, 2013

(54) DRIVER UNIT AND EARPHONE DEVICE

(71) Applicants: Yuusuke Oosato, Tokyo (JP); Koji Nageno, Tokyo (JP); Takahiro Suzuki, Saitama (JP)

(72) Inventors: Yuusuke Oosato, Tokyo (JP); Koji Nageno, Tokyo (JP); Takahiro Suzuki, Saitama (JP)

(73) Assignee: Sony Corporation, Tokyo (JP)

(21) Appl. No.: 13/561,880

(22) Filed: Jul. 30, 2012

(30) Foreign Application Priority Data
Sep. 5, 2011 (JP) 2011-192687

(51) Int. Cl. H04R 1/10; H04R 1/00

(52) U.S. Cl. 381/162

(57) ABSTRACT

Provided is a driver unit including an acoustic conversion unit; and a housing body in which the acoustic conversion unit is housed, and in which an opening is formed. The acoustic conversion unit includes a pair of magnets arranged to face each other, a coil to which an input signal is supplied, an armature at which a vibrating part passing through the coil and arranged between the pair of magnets is formed, and a vibrating plate connected to the armature. A size of the opening is larger than 40 μm and smaller than 100 μm.

### BACKGROUND

The present disclosure relates to, for example, a balanced armature driver unit and an earphone device.

As a system of a driver unit for earphone device, a balanced armature driver unit has been known. In the balanced armature driver unit, an armature (vibrator) vibrates in response to an electric signal supplied to a coil. By the vibration of the armature, a vibrating plate connected to the armature vibrates, whereby a sound is generated. The sound is emitted outside the driver unit and is introduced to the external acoustic meatus of the user using the earphone device via a sound conductive tube. The sound then reaches the tympanum of the user via the external acoustic meatus, so that the sound is perceived by the user using the earphone device. JP 2011-040933A discloses an earphone device which includes a balanced armature driver unit for low frequency range and a balanced armature driver unit for middle and high frequency ranges.

### SUMMARY

While the balanced armature driver unit is easy to downsize, the vibrating plate decreases in size and the low frequency range tends to lack sensitivity. To improve this point, for example, an LPF (Low Pass Filter) including a capacitor and an inductor is provided to the driver unit, and is applied to an input signal. The input signal to which the LPF has been applied is added to the original input signal, whereby a signal with an emphasized low frequency range is reproduced.

However, providing the LPF to the driver unit may lead to a problem in which the driver unit as a whole increases in size. This leads to a problem in which an earphone device equipped with the driver unit increases in size. Further, the technology disclosed in JP 2011-040933A requires that driver units having different shapes be respectively formed as driver units for the middle and high frequency ranges and for a low frequency range. Therefore, there is a problem that manufacturing of the driver units becomes costly.

Accordingly, the present disclosure provides a driver unit which is capable of reproducing a sound of a low frequency range without providing an LPF and the like.

According to an embodiment of the present disclosure, there is provided a driver unit including an acoustic conversion unit, and a housing body in which the acoustic conversion unit is housed, and in which an opening is formed. The acoustic conversion unit includes a pair of magnets arranged to face each other, a coil to which an input signal is supplied, an armature at which a vibrating part passing through the coil and arranged between the pair of magnets is formed, and a vibrating plate connected to the armature. A size of the opening is larger than 40 μm and smaller than 100 μm.

According to another embodiment of the present disclosure, there is provided an earphone device including at least two or more driver units being supported by a supporting part in an inner space formed by a housing. Each of the driver units includes an acoustic conversion unit, and a housing body in which the acoustic conversion unit is housed, and in which an opening is formed. The acoustic conversion unit includes a pair of magnets arranged to face each other, a coil to which an electrical signal is supplied, an armature at which a vibrating part passing through the coil and arranged between the pair of magnets is formed, and a vibrating plate connected to the armature. A size of the opening of one of the driver units is larger than 40 μm and smaller than 100 μm.

According to at least one embodiment, a sound of a low frequency range can be reproduced from a driver unit without providing an LPF and the like.

### BRIEF DESCRIPTION OF THE DRAWINGS

FIGS. 1A to 1E are a plan view and the like each showing an example of an appearance of a driver unit for woofer;

FIG. 2 is an exploded perspective view showing an example of a configuration of the driver unit for woofer;

FIG. 3 is a cross-sectional view showing an example of a cross-section of the driver unit for woofer;

FIGS. 4A to 4E are a plan view and the like each showing an example of an appearance of a full-range driver unit;

FIG. 5 is an exploded perspective view showing an example of a configuration of the full-range driver unit;

FIG. 6 is a cross-sectional view showing an example of a cross-section of the full-range driver unit;

FIG. 7 is a diagram illustrating an example of a frequency characteristic of a sound emitted from the driver unit;

FIG. 8 is a perspective view showing an example of a configuration inside a housing of an earphone device;

FIG. 9 is a schematic diagram showing an example of a configuration of a relay substrate;

FIG. 10 is a connection diagram illustrating an embodiment of connection of the driver unit;

FIG. 11 is an exploded view illustrating an example of a configuration of the earphone device;

FIG. 12 is a cross-sectional view illustrating an example of a cross-section of the earphone device;

FIG. 13 is a diagram illustrating an example of a frequency characteristic of a sound emitted from the earphone device;

FIGS. 14A and 14B are schematic diagrams illustrating another exemplary arrangement of the driver unit;

FIG. 15 is a schematic diagram illustrating another exemplary arrangement of the driver unit; and

FIG. 16 is a schematic diagram illustrating another exemplary shape of the driver unit.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments and modifications of the present disclosure will be described with reference to the appended drawings. The description will be given in the following order.

### <1. First Embodiment>

### <2. Modifications>

Note that, the present disclosure is not limited to the embodiments and the modifications described below.

### 1. First Embodiment

### Configuration of Driver Unit for Woofer

A driver unit exemplarily described below is a so-called “balanced armature driver unit”. First, the driver unit for woofer will be described.

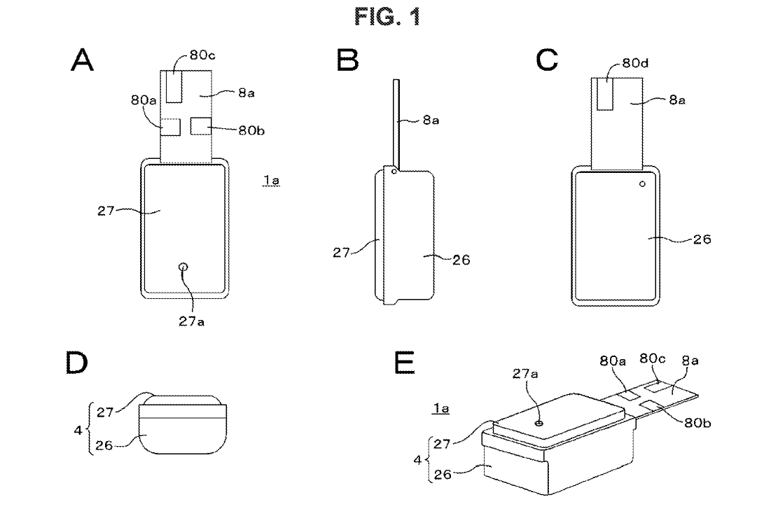

FIGS. 1A to 1E respectively show a plan view, a side view, a bottom view, a front view, and a perspective view of a driver unit 1a for woofer. The driver unit 1a has a housing body 4 made of resin and the like. The housing body 4 is, for example, formed of a case body 26 and a cover body 27, and an acoustic conversion unit described later is housed inside the housing body 4. The size (volume) of the housing body 4 is set so that the housing body 4 can be housed in an inner space of an earphone device.

A circuit substrate 8a formed of, for example, a flexible substrate is led out of the housing body 4. On one surface of the circuit substrate 8a, a conductive pattern 80a, a conductive pattern 80b, and a conductive pattern 80c are formed at predetermined intervals. To ensure an insulation distance between the conductive patterns, a conductive pattern 80d may be formed on the other surface of the circuit substrate 8a. The number of the conductive patterns to be formed and the positions at which the conductive patterns are formed can be properly changed. An input signal is supplied to the driver unit 1a via the conductive patterns.

A roughly circular opening 27a is formed in the cover body 27. The opening 27a is, for example, formed in a surface which faces a vibrating surface of a vibrating plate unit 3 inside the housing body 4 described later. The opening 27a is formed at a position which is deviated from the center of the cover body 27 in a longitudinal direction. Note that the position at which the opening 27a is formed is an example, and is not limited to the example shown in the drawing. For example, the opening 27a can be formed at another position on the cover body 27 or in the case body 26. Further, the opening 27a is not limited to the circle, and other forms such as a rectangle can be adopted.

The opening 27a is, for example, formed by drilling processing with a high-power volatile laser. As the laser, a carbon dioxide laser, an ultraviolet YAG laser, or the like can be used. By the drilling processing using laser, the opening 27a can be precisely formed. The diameter of the opening 27a is, for example, set to be larger than 40 μm (micrometer) and smaller than 100 μm. An acoustic inertance component of the opening 27a functions like a kind of LPF similar to an inductor. A sound generated by the acoustic conversion unit of the driver unit 1a is emitted from the opening 27a.

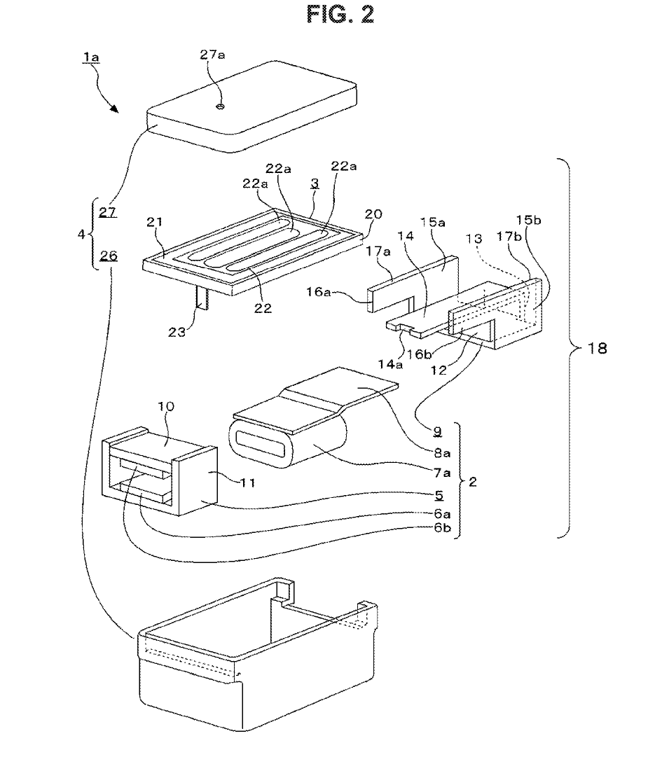

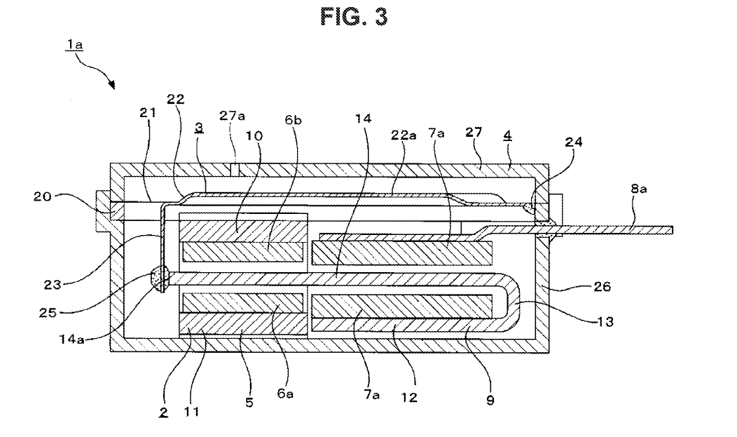

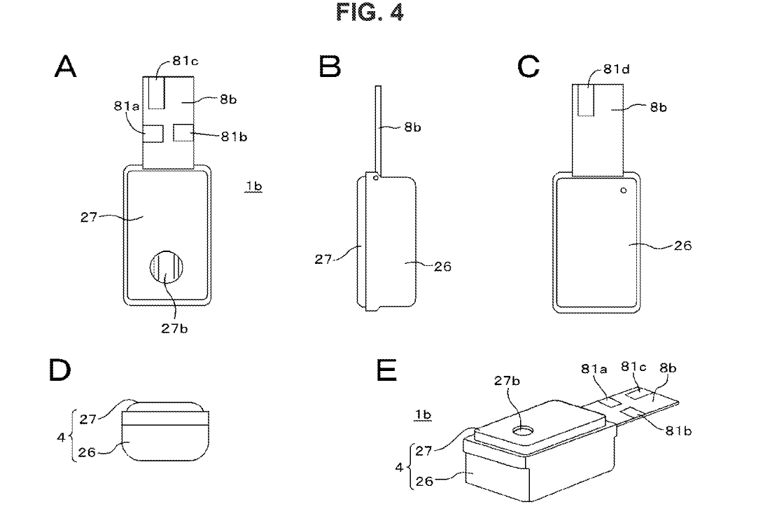

FIG. 2 shows an exploded perspective view of the driver unit 1a, and FIG. 3 shows a cross-sectional view of the driver unit 1a. Note that, in the following description of the driver unit 1a, the side shown by the front view of FIG. 1D is defined to be front, the side to which the circuit substrate 8a is led is defined to be rear, and the description of “front and rear”, “up and down”, and “right and left” will be properly used. However, the description of “front and rear”, “up and down”, and “right and left” is used merely for convenience, and the present disclosure is not limited to the described directions.

As shown in FIG. 2, the driver unit 1a includes the housing body 4 in which an acoustic conversion unit 18 formed of a driving unit 2 and the vibrating plate unit 3 is housed. The driving unit 2 includes a yoke 5, a pair of magnets 6a and 6b, a coil 7a, the circuit substrate 8a, and an armature 9.

The yoke 5 is formed of a plate-like first member 10 facing up and down direction and an angular U-shaped second member 11 opening upward. Right and left end surfaces of the member 10 are attached to inner surfaces in the vicinity of the opening part of the member 11 by adhesion, for example. With the members 10 and 11, the yoke 5 is formed in a square cylindrical shape having a through hole in the front-back direction.

The pair of magnets 6a and 6b is attached inside the yoke 5. The magnets 6a and 6b are separately arranged to face each other, and the facing sides have different polarities. The magnet 6a is attached to an under surface of the member 10, and the magnet 6b is attached to an upper surface of a bottom surface part of the member 11.

The coil 7a is formed in a cylindrical shape whose axis is in the front-back direction, and is also formed in a long-hole shape when seen in the front-back direction. The coil 7a is regularly wound, and upper and under surfaces thereof are formed flat. The circuit substrate 8a is attached to the upper surface of the coil 7a. The length of the circuit substrate 8a in the front-back direction is set to be longer than the length of the upper surface of the coil 7a in the front-back direction, and a part of the circuit substrate 8a is attached to the upper surface of the coil 7a.

Both end parts of the coil 7a are respectively connected to predetermined terminals at two positions of the circuit substrate 8a inside the housing body 4, thereby forming an electric circuit for supplying an input signal to the coil 7a. The predetermined terminals are, for example, electrically connected to the conductive patterns 80a and 80b via a through hole formed in the circuit substrate 8a. Note that, since the coil 7a is regularly wound and the upper surface thereof is formed flat, satisfactory joint condition between the coil 7a and the circuit substrate 8a can be ensured.

The armature 9 is made of magnetic metal material, for example, and each part is integrally formed. The armature 9 is formed of a plate-like coil attaching part 12 facing the up and down direction, a connection part 13 rising upward from the vicinity of the center of an rear end of the coil attaching part 12, a vibrating part 14 extending forward from an upper end portion of the connection part 13, side wall parts 15a and 15b respectively rising from both ends of the coil attaching part 12, a part to be fixed 16a extending forward from an approximately upper half portion of the side wall part 15a, and a part to be fixed 16b extending forward from an approximately upper half portion of the side wall part 15b.

A front end of the vibrating part 14 extending from the connection part 13 is positioned forward of a front end of the coil attaching part 12. The width of the vibrating part 14 in the right and left direction is set so that the vibrating part 14 can pass through the coil 7a. At the front end of the vibrating part 14, a recess for connection 14a recessed backward is formed.

An upper surface of the side wall part 15a and an upper surface of the part to be fixed 16a form the same plane. Also, an upper surface of the side wall part 15b and an upper surface of the part to be fixed 16b form the same plane. The respective planes separately arranged right and left function as fixing surfaces 17a and 17b.

The vibrating part 14 passes through the coil 7a, and the coil 7a is attached to an upper surface of the coil attaching part 12 by adhesion, for example. Since the coil 7a is regularly wound and the under surface thereof is formed flat, the coil 7a can be stably and surely attached to the coil attaching part 12. As shown in FIG. 3, in a state where the coil 7a is attached to the coil attaching part 12, the vibrating part 14 passes through the coil 7a, and a part of the vibrating part 14 protrudes forward.

In the driver unit 1a, the coil attaching part 12 to which the coil 7a is attached and the vibrating part 14 passing through the coil 7a are provided to the armature 9. Therefore, the position of the vibrating part 14 with respect to the coil 7a can be ensured with high precision, whereby accuracy of the positioning of the vibrating part 14 with respect to the coil 7a can be improved.

In a state where the coil 7a is attached to the coil attaching part 12, the armature 9 has the parts to be fixed 16a and 16b which are respectively fixed to outer surfaces of side surface parts of the yoke 5. The armature 9 is, for example, fixed to the yoke 5 by adhesion or welding. In the state where the armature 9 is fixed to the yoke 5, an upper surface of a side wall of the yoke 5 is positioned slightly higher than the fixing surfaces 17a and 17b of the armature 9. Also, the recess for connection 14a is positioned slightly forward of front end parts of the magnets 6a and 6b. Note that at least the vibrating part of the armature to be magnetized may just be made of metal material.

The vibrating plate unit 3 includes a holding frame 20, a resin film 21, a vibrating plate 22, and a beam part 23. The holding frame 20 is, for example, made of metal material, and is formed in a longitudinal frame shape in the front-back direction. The width of the holding frame 20 in the right and left direction is approximately the same as the width of the armature 9 in the right and left direction. The resin film 21 is approximately the same as an external form of the holding frame 20 in size, and is, for example, adhered to an upper surface of the holding frame 20 by adhesion or the like so as to block up an opening of the holding frame 20.

The vibrating plate 22 is formed of a thin component made of metal material, and an external form thereof is formed in a rectangular form slightly smaller than an inner form of the holding frame 20. The vibrating plate 22 is, for example, made of aluminum or stainless steel. Three reinforcing ribs 22a, 22a, and 22a are, for example, provided to the vibrating plate 22, each of the reinforcing ribs 22a being arranged apart from each other. The number of the reinforcing ribs 22a and the positions at which the reinforcing ribs 22a are provided can be properly changed. Each of the reinforcing ribs 22a is formed in a shape pushed upward. The vibrating plate 22 is adhered to an upper surface of the resin film 21.

A rear end of the vibrating plate 22 is positioned slightly forward of an inner surface at a rear end part of the holding frame 20, and a gap is formed between the rear end of the vibrating plate 22 and the inner surface at the rear end part of the holding frame 20. As shown in FIG. 3, an adhesive 24 is applied to fill the gap. As the adhesive 24, an acrylic non-curing type adhesive or an acrylic ultraviolet curing type adhesive can be used.

The vibrating plate 22 and the holding frame 20 are connected via the adhesive 24 and the resin film 21. Note that the adhesive 24 fills the gap and also extends to the other side of the surface which is adhered to the resin film 21 of the vibrating plate 22. That is, the vibrating plate 22 is supported to the holding frame 20 by the resin film 21, and the adhesive 24 functions as a reinforcing member for reinforcing this state.

The beam part 23 is, for example, integrally formed with the vibrating plate 22, and is formed in such a way that a part of the vibrating plate 22 is bent downward. The beam part 23 is, for example, formed in a narrow plate-like shape extending in the up and down direction.

The vibrating plate unit 3 is attached to the driving unit 2. An under surface of the holding frame 20 of the vibrating plate unit 3 is fixed to the fixing surfaces 17a and 17b of the armature 9. For example, the vibrating plate unit 3 is fixed to the driving unit 2 by adhesion or laser welding. When the vibrating plate unit 3 is fixed to the driving unit 2, a lower end part of the beam part 23 is attached to the vibrating part 14 of the armature 9. For example, after the lower end part of the beam part 23 is inserted into the recess for connection 14a at a front end of the vibrating part 14, an adhesive 25 is applied, whereby the lower end part of the beam part 23 is adhered to the vibrating part 14.

The beam part 23 is integrally formed with the vibrating plate 22. Therefore, by simply attaching the lower end part of the beam part 23 to the vibrating plate 14, the vibrating plate 22 and the armature 9 can be connected via the beam part 23, whereby a structure in which vibration of the vibrating part 14 is communicated to the vibrating plate 22 can be formed.

As described with reference to FIG. 1, the housing body 4 is formed of the box-like case body 26 having the upper surface opening upward and the recess at one of the side surfaces, and the shallow box-like cover body 27 having the under surface opening downward. For example, the opening 27a is formed in the upper surface of the cover body 27. In this example, the surface in which the opening 27a is formed is the surface facing the vibrating surface of the vibrating plate 22 housed inside the housing body 4. The surface in which the opening 27a is formed can be properly changed. As shown in FIG. 3, a sound generated by the vibration of the vibrating plate 22 is emitted to a space above the vibrating surface, so that the sound is emitted outside the housing body 4 from the opening 27a.

A recess is formed in the case body 26, and the circuit substrate 8a extends through the recess. For example, in the vicinity of the recess, an adhesive may be applied so that a part of the circuit substrate 8a is fixed to the housing body 4.

[Operation of Driver Unit for Woofer]

An example of operation of the driver unit 1a having the above-described configuration will be described. Positive and negative electrical signals as input signals are supplied to the circuit substrate 8a via a cable (not shown). The input signal is then supplied to the coil 7a via the circuit substrate 8a.

In response to the input signal supplied to the coil 7a, the vibrating part 14 of the armature 9 vibrates. The vibration of the vibrating part 14 is transmitted to the vibrating plate 22 via the beam part 23, so that the vibrating plate 22 vibrates. A sound is generated by the vibration of the vibrating plate 22. The generated sound is emitted to a space above the vibrating surface. Then, the sound emitted to the space above the vibrating surface is emitted outside the driver unit 1a via the opening 27a.

### [Configuration of Full-Range Driver Unit]

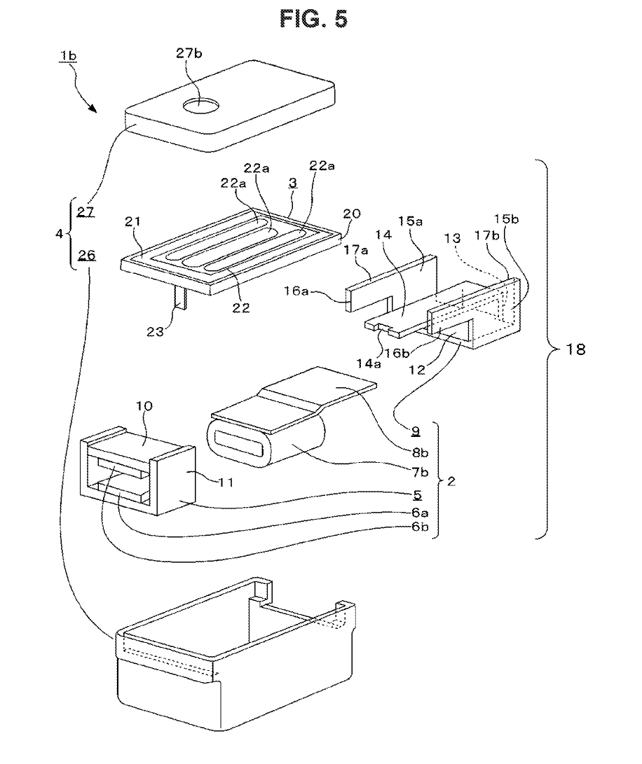

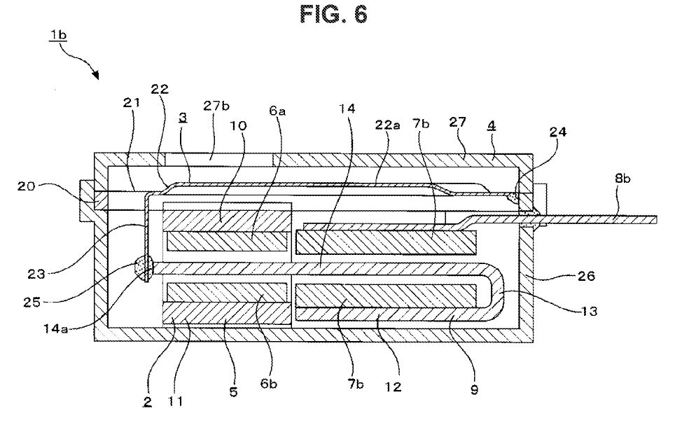

Next, a full-range driver unit will be described. FIGS. 4A to 4E respectively show a plan view, a side view, a bottom view, a front view, and a perspective view of a full-range driver unit 1b. FIG. 5 shows an exploded perspective view of the driver unit 1b, and FIG. 6 shows a cross-sectional view of the driver unit 1b. Note that, in the driver unit 1b, elements that have substantially the same configuration as those of the driver unit 1a for woofer are denoted with the same reference signs, and repeated explanation is omitted.

As exemplarily shown in FIGS. 4 to 6, the driver unit 1b has substantially the same configuration as the driver unit 1a. The diameter of an opening 27b formed in a cover body 27 of the driver unit 1b differs from that of the opening 27a. The diameter of the opening 27b is, for example, 1.5 mm (millimeter).

The configuration of the driver unit 1b can be made different from that of the driver unit 1a. However, by simply changing the diameter of the opening, the driver unit can function as either a driver unit for woofer or a full range driver unit. That is, by properly setting an output of a laser, openings having different diameters can be formed, whereby the driver unit for woofer and the full range driver unit can be easily manufactured. It is not necessary to change the shape or the size of the housing body or to change the configuration of the acoustic conversion unit. Therefore, the cost for manufacturing the driver unit can be reduced and manufacturing efficiency can be improved.

Note that, for the convenience of later description, a circuit substrate of the driver unit 1b is represented as a circuit substrate 8b. Conductive patterns formed on the circuit substrate 8b are represented as a conductive pattern 81a, a conductive pattern 81b, a conductive pattern 81c, and a conductive pattern 81d. A coil 7b provided in the driver unit 1b has substantially the same shape as the coil 7a. Both ends of the coil 7b are connected to predetermined terminals at two positions on the circuit substrate 8b. The predetermined terminals at the two positions are electrically connected to the conductive patterns 81a and 81b, respectively.

### [Size of Opening]

A reason why the driver unit la functions as a driver unit for woofer by causing the size of the opening 27a of the driver unit 1a to be narrow and small will be described. A sound conductor path of a sound generated by vibration of the vibrating plate 22 is narrowed by the opening 27a. An (acoustic) inertance component by the opening 27a functions as a kind of LPF similar to a series inductor. Inertance is viscosity when air flows through a narrow tube, and is inversely proportional to a cross-section and is proportional to a length. Here, the opening 27a is likened to a tube, and where the diameter of the opening 27a is A (μm) and the length is L (mm), the cross-section S of the opening 27a is obtained by the following formula (1).

S=(A/2)²*π Formula (1)

(In Formula (1), “/” means division, and “π” means the circular constant.)

The inertance component is obtained by the following formula (2).

Ma=4ρL/3S Formula (2)

Unit: (kg/m⁴)
(In Formula (2), “ρ” means density of gas.)

Here, the length L of the opening 27a of the driver unit 1a corresponds to the thickness of the case body 26. Where L is 0.2 mm, ρ is the density of air of 1.29 (kg/m³), and these values are substituted into Formula (2), the following table 1 can be obtained as the inertance with respect to the diameter A.

TABLE 1

| Diameter A (μm) | Ma (kg/m⁴) * 10³ |
|---|---|
| 100 | 43 |
| 80 | 68 |
| 70 | 89 |
| 60 | 121 |
| 50 | 175 |
| 40 | 273 |

As shown in Table 1, the smaller the diameter A is, the larger load occurs due to the inertance.

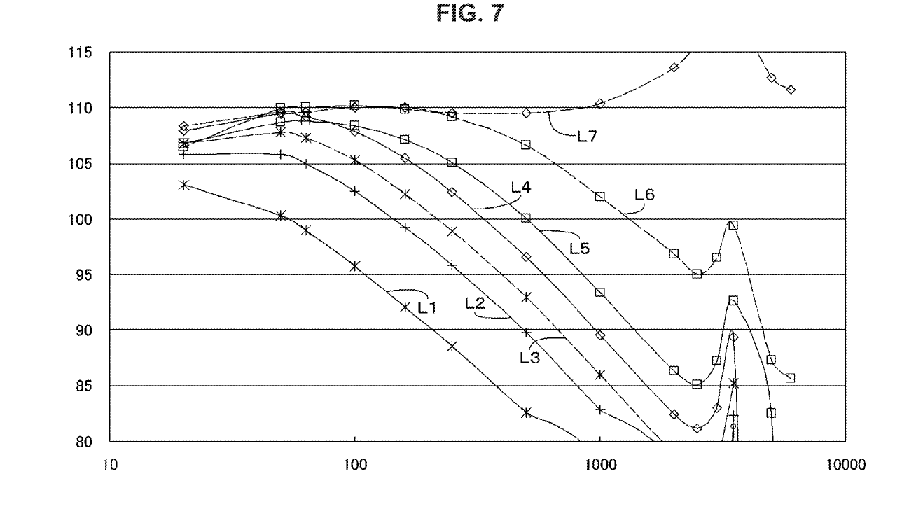

FIG. 7 shows an example of a frequency characteristic of a sound that is emitted from the opening when the value of the diameter A is changed. In the graph, the vertical axis corresponds to sound pressure level (dB), and the horizontal axis corresponds to frequency (Hz). In the graph, a line L1 shows the characteristic when the diameter of the opening is 40 μm, a line L2 shows the characteristic when the diameter of the opening is 50 μm, a line L3 shows the characteristic when the diameter of the opening is 60 μm, a line L4 shows the characteristic when the diameter of the opening is 70 μm, a line L5 shows the characteristic when the diameter of the opening is 80 μm, a line L6 shows the characteristic when the diameter of the opening is 100 μm, and a line L7 shows the characteristic when the diameter of the opening is 150 μm.

As shown in FIG. 7, as the diameter A is smaller, the load due to the inertance becomes larger and the cut-off frequency becomes lower. Here, a range exhibited by the characteristic of the diameter A of 100 μm corresponds to the midrange. Therefore, to cause a driver unit to function as the driver unit for woofer, it is preferable that the diameter A of the opening 27a be smaller than 100 μm. Meanwhile, making the diameter A too small may cause deterioration of sensitivity. When the diameter A is smaller than 40 μm (for example, 40 μm or less), the sensitivity is lowered. Therefore, as a driver unit which shows the characteristic of woofer, it is preferable that the diameter A of the opening 27a be larger than 40 μm and be smaller than 100 μm. By simply changing the diameter of the opening, a driver unit having a desired characteristic can be configured.

As shown in the line L7 in FIG. 7, where the diameter A is about 1.5 mm, the driver unit exhibits a full range characteristic. Therefore, to cause a driver unit to function as the full-range driver unit, the diameter A may be just set to be about 1.5 mm, for example.

Note that, a driver unit for tweeter (hereinafter, properly referred to as driver unit 1c) can be configured by using a network. The driver unit 1c has, for example, substantially the same configuration as the full-range driver unit 1b, and a diameter of an opening 27c provided to the driver unit 1c is, for example, about 1.5 mm. At a front stage of the driver unit 1c, an HPF (High Pass Filter) as the network is provided. The HPF is, for example, configured from a capacitor.

An input signal whose low frequency range component has been cut by the HPF is provided to the driver unit 1c. The driver unit 1c generates a sound of a high frequency range in response to the input signal. The sound of the high frequency range is emitted from the opening 27c of the driver unit 1c. Note that, the HPF can be applied to the emitted sound from the driver unit 1c. By using the network, a driver unit for tweeter can be configured.

A network configured from an LPF can be provided to the driver unit 1a. By using the network configured from the LPF in addition to causing the opening 27a to be narrow and small, more precise filtering can be possible, whereby a sound of a low frequency range emitted from the opening 27a can be strengthened.

### [Earphone Device]

An example of an earphone device to which the driver unit 1a for woofer can be applied will be described. The earphone device includes a housing, and at least two or more driver units are supported by a supporting part in an inner space formed by the housing. For example, a driver unit for woofer and a full-range driver unit are supported by the supporting part.

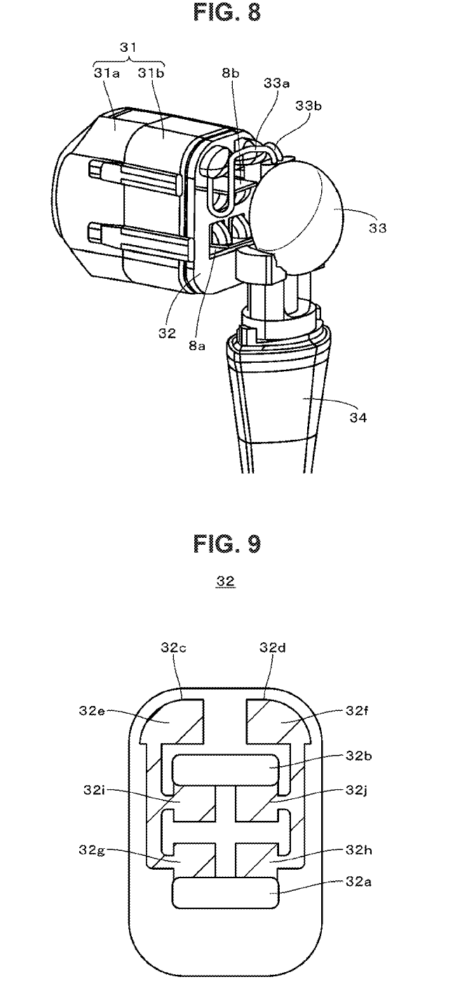

FIG. 8 shows an example of a configuration inside the housing of an earphone device 30. An inner housing 31 as an example of the supporting part is, for example, formed by combining a front inner housing 31a and a rear inner housing 31b. At the front inner housing 31a, for example, insertion openings for inserting two or more driver units are formed in the direction of layering. In this example, two insertion openings are formed in the front inner housing 31a.

To the insertion openings of the front inner housing 31a, the driver units 1a and 1b are respectively inserted. After the insertion, the front inner housing 31a and the rear inner housing 31b are combined. When the front inner housing 31a and the rear inner housing 31b are combined, an inner surface of the rear inner housing 31b comes in contact with each driver unit. By the front inner housing 31a and the rear inner housing 31b, the driver units 1a and 1b are layered and supported. Note that a gap caused between the inner housing 31 and the driver unit 1a or the driver unit 1b can be filled with an adhesive so that the driver units 1a and 1b are firmly fixed.

As the material for the inner housing 31, for example, light and solid magnesium can be used. By using magnesium, the inner housing 31 can be thinner and downsized. By integrating the inner housing 31 and the driver units 1a and 1b, unnecessary vibration of each driver unit can be prevented.

At the rear inner housing 31b, openings are formed in the other end surface of the surface which is combined with the front inner housing 31a, the number of the openings corresponding to the number of the insertion openings. For example, two openings are formed in the rear inner housing 31b. The circuit substrate 8a of the driver unit 1a and the circuit substrate 8b of the driver unit 1b are respectively led out of the two openings. A relay substrate 32 is attached to an end surface of the side where the openings of the rear inner housing 31b are formed. Two openings are formed in the relay substrate 32, for example. The circuit substrates 8a and 8b led out of the rear inner housing 31b pass through the openings formed at the relay substrate 32 respectively.

A cord 33a extending from a core wire 33 is connected to the relay substrate 32. The cord 33a is fixed at a predetermined portion of the relay substrate 32 by soldering, for example. A signal of positive polarity is supplied via the cord 33a. Further, a cord 33b extending from the core wire 33 is connected to the relay substrate 32. The cord 33b is fixed at a predetermined portion of the relay substrate 32 by soldering, for example. A signal of negative polarity is supplied via the cord 33b. Note that, to protect the core wire 33, a cover 34 made of resin or the like can be provided.

FIG. 9 shows an example of a configuration of an end surface of the relay substrate 32. Openings 32a and 32b are formed in the relay substrate 32, for example. The circuit substrate 8a of the driver unit 1a passes through the opening 32a, and a part of the circuit substrate 8a extends therethrough. The circuit substrate 8b of the driver unit 1b passes through the opening 32b, and a part of the circuit substrate 8b extends therethrough.

Insulated conductive patterns 32c and 32d are formed on the relay substrate 32. In FIG. 9, the conductive patterns 32c and 32d are marked with slant lines. In the vicinity of an end part of the conductive pattern 32c shown by the reference number 32e, the cord 33a is fixed by soldering, for example. A positive input signal is supplied to the conductive pattern 32c via the cord 33a. In the vicinity of an end part of the conductive pattern 32d shown by the reference number 32f, the cord 33b is fixed by soldering, for example. A negative input signal is supplied to the conductive pattern 32d via the cord 33b.

The vicinity of the center of the conductive pattern 32c shown by the reference number 32g and the conductive pattern 80a of the circuit substrate 8a are fixed by soldering, for example. The vicinity of the center of the conductive pattern 32c shown by the reference number 32h and the conductive pattern 80b of the circuit substrate 8a are fixed by soldering, for example. By the soldering, positive and negative input signals are supplied to the circuit substrate 8a, and the input signals are supplied to the coil 7a connected to the circuit substrate 8a.

The vicinity of the center of the conductive pattern 32c shown by the reference number 32i and the conductive pattern 81a of the circuit substrate 8b are fixed by soldering, for example. The vicinity of the center of the conductive pattern 32c shown by the reference number 32j and the conductive pattern 81b of the circuit substrate 8b are fixed by soldering, for example. By the soldering, positive and negative input signals are supplied to the circuit substrate 8b, and the input signals are supplied to the coil 7b connected to the circuit substrate 8b. Note that, at the relay substrate 32, the positions where the openings and the conductive patterns are formed and the cords are fixed by soldering are one example, and the positions are not limited to the example.

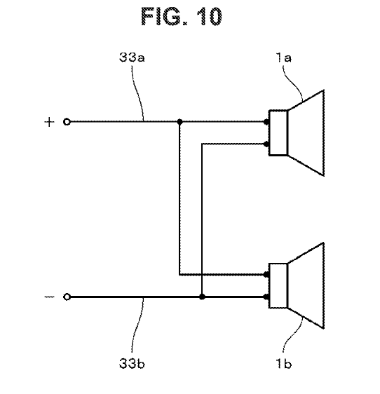

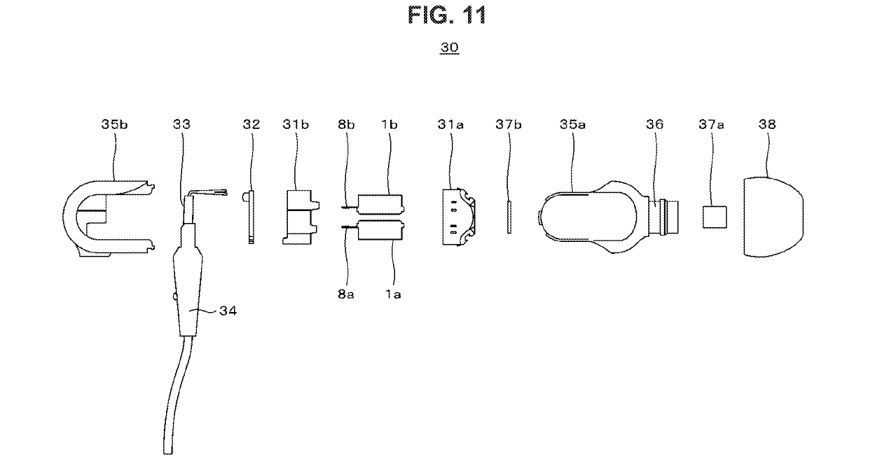

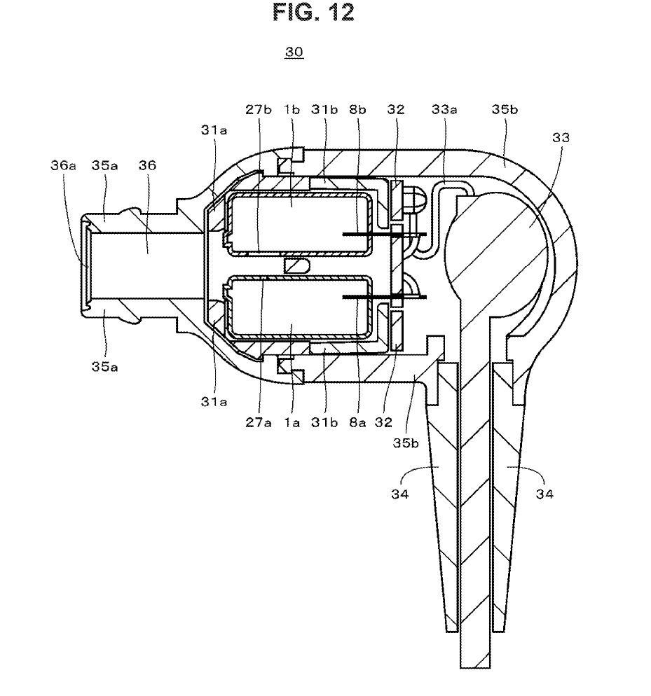

FIG. 10 shows an example of connection of a driver unit. In FIG. 10, the driver units 1a and 1b are respectively shown as speakers. Positive input signals supplied via the cord 33a are branched, and the branched positive input signals are respectively supplied to the driver units 1a and 1b. Negative input signals supplied via the cord 33b are branched, and the branched negative input signals are respectively supplied to the driver units 1a and 1b.

The positive and negative input signals are supplied to the coil 7a of the driver unit 1a. The positive and negative input signals are supplied to the coil 7b of the driver unit 1b. By the exemplary connection shown in FIG. 10, the driver units 1a and 1b are connected in parallel.

FIG. 11 shows an example of an exploded view of the earphone device 30. The earphone device 30 includes a housing 35 which is formed by combining a front housing 35a and a rear housing 35b. The housing 35 is made of metal such as stainless steel.

The front housing 35a and the rear housing 35b have spaces inside thereof respectively, which form a space inside the housing 35. A sound conductive tube 36 is integrally formed with the front housing 35a. An equalizer 37a for adjusting the balance of a predetermined range may be attached to the sound conductive tube 36. In the vicinity of the sound conductive tube 36 of the front housing 35a, an earpiece 38 is engaged. The earpiece 38 is made of elastic material such as silicon rubber or elastomer, and changes its shape in accordance with the shape of the external acoustic meatus of the user.

In the inner space formed by the housing 35, the front inner housing 31a is housed. The driver units 1a and 1b are inserted into the insertion openings of the front inner housing 31a. The rear inner housing 31b is combined with the front inner housing 31a, and the driver units 1a and 1b are supported by the inner housing 31. In the vicinity of an end surface of the front inner housing 31a at the side of the sound conductive tube 36, an equalizer 37b for adjusting the balance of a predetermined range can be attached.

The circuit substrate 8a of the driver unit 1a and the circuit substrate 8b of the driver unit 1b are respectively led out of the openings of the rear inner housing 31b, and pass through an opening of the relay substrate 32. The relay substrate 32 is attached to an end surface of the rear inner housing 31b. Positive and negative signals supplied from the core wire 33 are supplied to each of the circuit substrates via the relay substrate 32. The cover 34 for protection can be provided to the core wire 33.

FIG. 12 shows an example of a cross-section of the earphone device 30. In FIG. 12, the drawing of the cross-section of the earpiece and the configuration inside the driver units 1a and 1b are properly omitted. The inner space is formed by the housing 35 which is formed of the front housing 35a and the rear housing 35b. The sound conductive tube 36 is formed in the front housing 35a, and a sound is output via a sound emission hole 36a at a tip of the sound conductive tube 36.

The front inner housing 31a is attached to an inner surface of the front housing 35a, and is fixed by adhesion. The driver units 1a and 1b are respectively inserted into the insertion openings formed by the front inner housing 31a. For example, the driver unit 1a is inserted into the insertion opening at the lower side in the drawing, and the driver unit 1b is inserted into the insertion opening at the upper side. At this time, for example, the driver units 1a and 1b are respectively inserted into the openings in such a way that the openings 27a and 27b face each other.

The rear inner housing 31b is combined with the front inner housing 31a. An inner surface of the rear inner housing 31b comes in contact with the driver units 1a and 1b. The driver units 1a and 1b are layered and supported by the front inner housing 31a and the rear inner housing 31b. A sound generated by the operation of the driver unit 1a is emitted from the opening 27a. A sound generated by the operation of the driver unit 1b is emitted from the opening 27b. The sounds emitted from the respective openings are synthesized inside the housing 35. The synthesized sound is emitted from the sound emission hole 36a of the sound conductive tube 36, whereby the sound is reproduced from the earphone device 30.

A part of the circuit substrate 8a led out of the driver unit 1a passes through the opening formed in the relay substrate 32. A predetermined position of the conductive pattern at a portion of the circuit substrate 8a, the portion having passed through the opening, is fixed to a predetermined portion of the relay substrate 32 by soldering, for example. A part of the circuit substrate 8b led out of the driver unit 1b passes through an opening formed in the relay substrate 32. A predetermined position of the conductive pattern at a portion of the circuit substrate 8b, the portion having passed through the opening, is fixed to a predetermined portion of the relay substrate 32 by soldering, for example.

Positive and negative signals are supplied to the relay substrate 32 via the cord 33a and the like of the core wire 33. The positive and negative signals are supplied to each of the circuit substrates 8a and 8b via the relay substrate 32. In the inner space formed by the housing 35, the vicinity of an end part of the core wire 33 is housed. The end part of the core wire 33 has a rounded shape, for example, and the cords 33a and 33b extend from the end part. The cords 33a and 33b are connected to predetermined positions of the relay substrate 32. The core wire 33 extends from the lower opening of the rear housing 35b. The cover 34 for protection is attached around the core wire 33, for example, and the core wire 33 passes through the interior of the cover 34.

### [Frequency Characteristic of Sound]

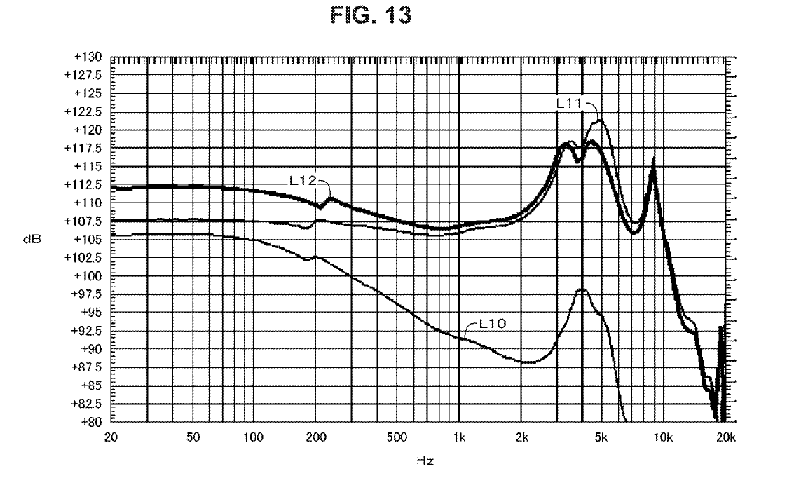

FIG. 13 shows an example of a frequency characteristic of a sound. A line L10 in the graph shows a frequency characteristic of a sound emitted from the opening 27a of the driver unit 1a. A line L11 shows a frequency characteristic of a sound emitted from the opening 27b of the driver unit 1b. A line L12 shown by bold line shows a frequency characteristic of a sound reproduced from the earphone device 30.

By synthesizing the sounds emitted from the opening 27a, the level of a low frequency range (for example, the range of 500 Hz or less) of the sound emitted from the earphone device 30 can be strengthened. In this way, in the earphone device according to the present disclosure, the low frequency range can be strengthened by simply setting the diameter of the opening formed in the driver unit properly. Therefore, the low frequency range can be strengthened without using the network, whereby the sound quality reproduced from the earphone device can be improved. Further, the earphone device can be downsized.

### 2. Modifications

As described above, a plurality of embodiments has been concretely described. However, various modifications are obviously possible. Hereinafter, the modifications will be described.

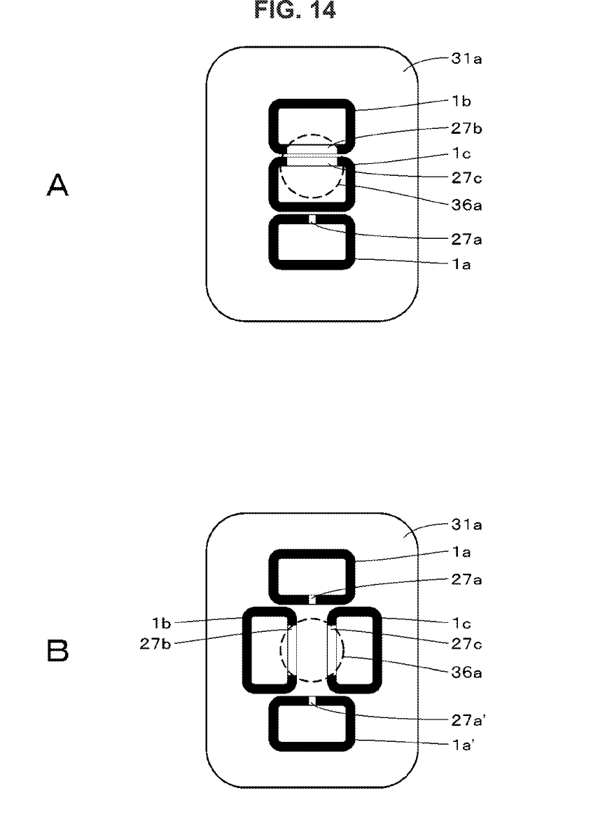

In the embodiments described above, an earphone device configured from two driver units (two-way) has been described. However, the earphone device can be configured from a multi-way system such as three-way or four-way. FIG. 14A shows an outline regarding an arrangement of driver units when the earphone device is configured from the three-way system.

At a front inner housing 31a in the modification shown in FIG. 14A, three insertion openings are formed. To the three insertion openings, a full-range driver unit 1b, a driver unit 1c for tweeter, and a driver unit 1a for woofer are inserted and supported in this order, for example. At this time, for example, an opening 27b of the driver unit 1b and an opening 27c of the driver unit 1c may be caused to face each other.

Sounds emitted from the openings 27a, 27b, and 27c are synthesized inside a housing 35. The synthesized sound is emitted from a sound emission hole 36a of a sound conductive tube 36. By further providing the driver unit 1c for tweeter, a sound whose high frequency range is strengthened can be reproduced from the earphone device.

FIG. 14B shows an outline regarding an arrangement of driver units when the earphone device is configured from the four-way system. At a front inner housing 31a of another modification shown in FIG. 14B, four insertion openings are formed. For example, at the front inner housing 31a, two insertion openings are formed in the up and down direction and two insertion openings are formed in the right and left direction.

With respect to the insertion openings in the up and down direction, a driver unit 1a for woofer and a driver unit 1a′ for super woofer are respectively inserted and supported. With respect to the insertion openings in the right and left direction, a full-range driver unit 1b and a driver unit 1c for tweeter are respectively inserted and supported.

The driver unit 1a′ has substantially the same configuration as the driver unit 1a, and an opening 27a′ is formed in the driver unit 1a'. The diameter of an opening 27a of the driver unit 1a is 60 μm, for example, and the driver unit 1a functions as a driver unit for woofer. The diameter of the opening 27a′ of the driver unit 1a′ is 50 μm, for example, and the driver unit 1a′ functions as a driver unit for super woofer.

The driver units 1a and 1a′ are supported in such a way that the openings 27a and 27a′ face each other. The driver units 1b and 1c are supported in such a way that the openings 27b and 27c face each other. A sound generated by the driver unit 1a is emitted from the opening 27a. A sound generated by the driver unit 1a′ is emitted from the opening 27a′. A sound generated by the driver unit 1b is emitted from the opening 27b. A sound generated by the driver unit 1c is emitted from the opening 27c. The sounds emitted from the respective openings are synthesized inside a housing 35, and the synthesized sound is emitted from a sound emission hole 36a of a sound conductive tube 36. From the earphone device, a sound having a further strengthened low frequency range and improved sound quality is reproduced.

Note that, each driver unit can be supported in such a way that the distance from the sound emission hole 36a to the opening of the driver unit for woofer is maximized among the distances from the sound emission hole 36a to the respective openings of the driver units. As the outline is shown in FIG. 15, the distance from the center of the sound emission hole 36a to the center of the opening 27a can be, for example, larger than the distances from the center of the sound emission hole 36a to the centers of the openings 27b and 27c. In other words, a transmission distance of an emitted sound from the opening 27a to the sound emission hole 36a can be maximized.

A sound generated by the driver unit 1a passes through the opening 27a having high acoustic impedance. Therefore, attenuation of the sound which is caused during the sound being transmitted from the opening 27a to the sound emission hole 36a is small. On the other hand, sounds generated by the driver units 1b and 1c respectively pass through the openings 27b and 27c having low acoustic impedance. Therefore, the sounds having passed through the openings 27b and 27c are easily attenuated during the sound being transmitted from each of the openings to the sound emission hole 36a. When arranging a plurality of driver units, by causing the distance from the sound emission hole 36a to the opening 27a to be large, and causing the openings 27b and 27c to come close to the sound emission hole 36a, a sound having a strengthened low frequency range can be reproduced without attenuating middle and high frequency ranges.

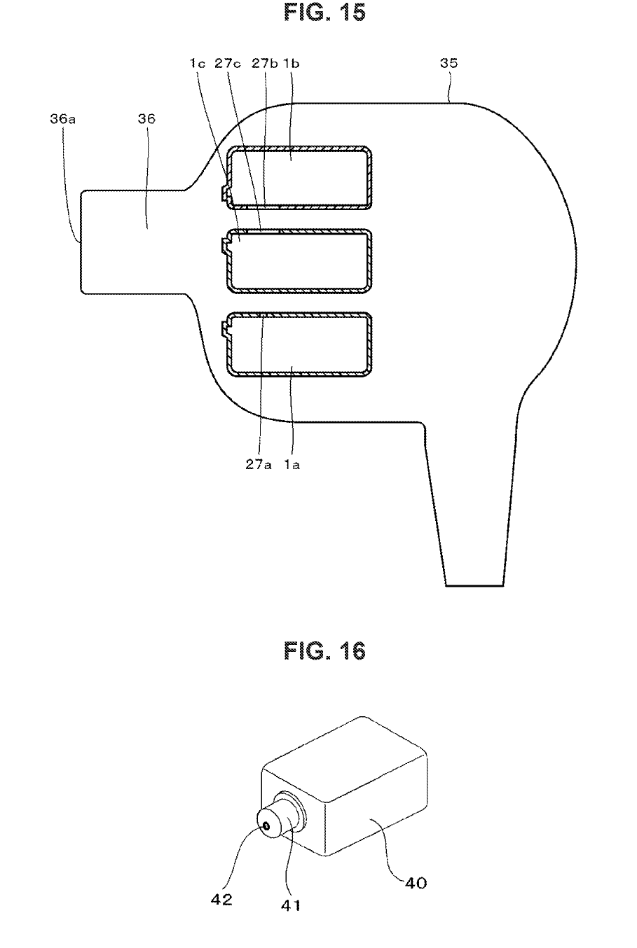

The housing body of the driver unit is not limited to the box shape. FIG. 16 shows an example of another shape of the housing body of the driver unit. The housing body of a driver unit 40 has a shape including a funnel-shaped member 41. A mesh film may be formed at a tip of the member 41, and an opening may be formed in the film. For example, at the tip of the member 41, an opening having a form identical to the openings 27a or 27b may be formed.

Whole or a part of the embodiments and modifications described above may be mutually combined insofar as they are within the scope of the appended claims or the equivalents thereof. The illustrated arrangements of materials and members may be properly altered without departing from the spirit or scope of the appended claims.

Additionally, the present disclosure may also be configured as below.

(1) A driver unit comprising:

an acoustic conversion unit; and

a housing body in which the acoustic conversion unit is housed, and in which an opening is formed,

wherein the acoustic conversion unit includes

a pair of magnets arranged to face each other,

a coil to which an input signal is supplied,

an armature at which a vibrating part passing through the coil and arranged between the pair of magnets is formed, and

a vibrating plate connected to the armature, and

wherein a size of the opening is larger than 40 μm and smaller than 100 μm.

(2) An earphone device comprising:

at least two or more driver units being supported by a supporting part in an inner space formed by a housing,

wherein each of the driver units includes

an acoustic conversion unit, and

a housing body in which the acoustic conversion unit is housed, and in which an opening is formed,

wherein the acoustic conversion unit includes

a pair of magnets arranged to face each other,

a coil to which an electrical signal is supplied,

an armature at which a vibrating part passing through the coil and arranged between the pair of magnets is formed, and

a vibrating plate connected to the armature, and

wherein a size of the opening of one of the driver units is larger than 40 μm and smaller than 100 μm.

(3) The earphone device according to (2),

wherein the one driver unit and another driver unit are layered and supported, and

wherein the size of the opening of the other driver unit is larger than the size of the opening of the one driver unit.

(4) The earphone device according to (2) or (3),

wherein the opening of the one driver unit and the opening of the other driver unit are supported to face each other.

(5) The earphone device according to any one of (2) to (4),

wherein a sound conductive part is formed by the housing, and

wherein among distances from a tip end of the sound conductive part to the respective openings, the distance from the tip end of the sound conductive part to the opening of the one driver unit is the largest.

(6) The earphone device according to any one of (2) to (5),

wherein each of the housing bodies of the driver units has approximately the same size.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-192687 filed in the Japan Patent Office on Sep. 5, 2011, the entire content of which is hereby incorporated —.

What is claimed is:

1. A driver unit comprising:
an acoustic conversion unit; and
a housing body in which the acoustic conversion unit is housed, and in which an opening is formed,
wherein the acoustic conversion unit includes
a pair of magnets arranged to face each other,
a coil to which an input signal is supplied,
an armature at which a vibrating part passing through the coil and arranged between the pair of magnets is formed, and
a vibrating plate connected to the armature, and
wherein a size of the opening is larger than 40 μm and smaller than 100 μm.

2. An earphone device comprising:
at least two or more driver units being supported by a supporting part in an inner space formed by a housing,
wherein each of the driver units includes
an acoustic conversion unit, and
a housing body in which the acoustic conversion unit is housed, and in which an opening is formed,
wherein the acoustic conversion unit includes
a pair of magnets arranged to face each other,
a coil to which an electrical signal is supplied,
an armature at which a vibrating part passing through the coil and arranged between the pair of magnets is formed, and
a vibrating plate connected to the armature, and
wherein a size of the opening of one of the driver units is larger than 40 μm and smaller than 100 μm.

3. The earphone device according to claim 2,
wherein the one driver unit and another driver unit are layered and supported, and
wherein the size of the opening of the other driver unit is larger than the size of the opening of the one driver unit.

4. The earphone device according to claim 3,
wherein the opening of the one driver unit and the opening of the other driver unit are supported to face each other.

5. The earphone device according to claim 2,
wherein a sound conductive part is formed by the housing, and
wherein among distances from a tip end of the sound conductive part to the respective openings, the distance from the tip end of the sound conductive part to the opening of the one driver unit is the largest.

6. The earphone device according to claim 2,
wherein each of the housing bodies of the driver units has approximately the same size.
